(19) United States
(12) Patent Application Publication
(10) Pub. No.: US 2005/0151395 A1
(43) Pub. Date: Jul. 14, 2005

(54) Water catching strip with a water catching channel disposed between a vehicle a-pillar and windshield

(75) Inventors: Patrick Hoefer, Stuttgart (DE); Alexander Moessner, Leonberg (DE); Ulrich Paetzold, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/014,880

(22) Filed: Dec. 20, 2004

(30) Foreign Application Priority Data
Dec. 19, 2003 (DE) 103 59 833.2

(51) Int. Cl. B60J 10/00

(52) U.S. Cl. 296/208

(57) ABSTRACT

A water catching strip is provided between a vehicle windshield and a vehicle A-pillar. The strip has a water catching channel adjoining a windshield between the windshield and a water catching web of the strip projecting at a distance with respect to this windshield. The strip has a predominantly smooth outer surface and is designed to be improved with respect to its effect of preventing a driving-air-flow-caused lateral flowing-off of rain water from the vehicle front area onto the side windows. The strip includes the following features: the edge of the water catching web pointing to the windshield is constructed as a flow divider for rain water flowing laterally off the windshield; a groove extends parallel to the edge engaging in the outer surface of the strip at a narrow distance to its water catching web edge; the groove extends along the entire length of the strip and extends out of the latter in an open manner at least at the top; the groove extends in a region of the strip in which, when driving air flow exists, a flow separation is formed downstream of the edge of the water catching web.

### BACKGROUND AND SUMMARY OF THE INVENTION

This application claims the priority of German Application No. 103 59 833.2 filed Dec. 19, 2003, the disclosure of which is expressly incorporated by reference herein.

The invention relates to a water catching strip with a water catching channel disposed between a vehicle A-Pillar and a windshield. Certain preferred embodiments of the invention relate to a water catching strip which in use is interposed between a vehicle windshield and a vehicle A-pillar the water catching strip includes, a water catching channel adjoining a windshield formed between the windshield and a water catching web of the strip projecting at a distance with respect to the windshield, the strip having a predominantly smooth outer surface.

From German Patent Document DE 1 630 375 C2 (corresponding U.S. Pat. No. 3,583,757), a windshield sealing device is known which is mounted on an A-pillar of a vehicle and has a molded-on water catching strip. In this case, the water catching strip is equipped with two horizontally adjacent catching channels, of which the first adjoins the windshield directly and, viewed from the windshield, the second is arranged at a distance parallel behind the first catching channel. Both catching channels have an approximately U-shaped cross-section, this cross-section being oriented such that the U-legs each extend approximately parallel to the windshield. Rain water flowing off laterally from the windshield while the vehicle is driving can thereby be caught and carried off upward and/or downward. As a result, the side windows are to be kept free of rain water flowing laterally off the windshield.

From European Patent Document EP 03 10 262 B1 (corresponding U.S. Pat. No. 5,107,646), another windshield sealing device is known on the respective A-pillars of a vehicle, in the case of which a water catching channel is provided at the transition to the windshield. This sealing device is not a component of an A-pillar front cover.

The invention relates to the problem of keeping the side windows of a vehicle, which has a water catching strip front cover of the above-mentioned type containing a single water catching channel directly adjacent to the windshield, as completely has possible free of rain water, specifically at slow as well as high driving speeds.

This problem is solved according to certain preferred embodiments of the invention by a construction of a water catching strip which in use is interposed between a vehicle windshield and a vehicle A-pillar comprising a watch catching channel adjoining a windshield formed between the windshield and a water catching web of the strip projecting at a distance with respect to the windshield, the strip having a predominantly smooth outer surface, wherein the edge of the water catching web pointing away from the A-pillar toward the windshield is constructed as a flow divider for rain water flowing laterally off the windshield, wherein a groove extends parallel to an edge of the strip in an outer surface of the strip at a narrow distance from its water catching web edge, wherein the groove extends along substantially the entire length of the strip and extends out of the latter in an open manner at least at the top, and wherein the groove extends in a region of the strip in which, when driving air flow exists, a flow separation is formed downstream of the edge of the water catching web.

Advantageous and expedient further developments of the preferred embodiments of the invention are described herein and in the claims.

Certain preferred embodiments of the invention are based on the following recognition.

In the case of a water catching strip with a certain width of an A-pillar, attention should not only be paid to the fact that rain water flowing off laterally from the windshield is completely carried away in the water catching channel directly adjoining the windshield but also that rain water striking the front cover itself cannot reach the side windows. Flow tests carried out in the wind tunnel have shown that, particularly in the area of the edge of the water catching web projecting from the front cover at a distance over the windshield, rain water flows off by way of the front cover of the water catching strip toward the side in such an amount that the side window is considerably soiled with rain water. In this case, it was found that such an action of rain water upon the side windows is particularly problematic with respect to a soiling of the side windows at low to medium driving speeds. In addition to the rain water fraction which accumulates in the above-mentioned sense on the respective windshield-side edge area of the front covers, there is also the rain water directly striking the front cover.

Based on this previously not known recognition, the invention provides two measures whose effects supplement one another and which are independent per se.

One of these measures comprises constructing the edge area of the projecting water catching web of the front cover of the water catching strip, which edge area points toward the windshield, in such a manner that it can be used as a flow divider for rain water flowing off the windshield. This flow divider is to be designed such that, on this edge area, as much rain water as possible is deflected directly into the windshield-side water catching channel. In an ideal case, this object is achieved by means of a knife-blade-shaped construction of the edge area. In practice, for reasons of accident protection, as a rule, such an ideal construction will at least not be possible unless at least this edge area of the front cover consists of a soft, elastically flexible material. If the material in the corresponding edge area is not soft, for reasons of accident protection, a rounding-off with a rounding-off radius, which is not too small, is required so that a person impacting onto this area in the event of an accident will not be particularly seriously injured.

It should definitely be endeavored according to certain preferred embodiments of the invention that the edge area tapering to a point is oriented such that
a) its surface projected with respect to the local flow direction is as small as possible and thus also the surface wetted by drops of water;
b) the described, spatially limited separation area is formed; and
c) the separation is not too large in order to avoid disturbing wind noise.

The second measure comprises providing, at a relatively small distance from the front edge of the water catching web, a flat and narrow groove in the top surface of the front cover of the water catching strip, which groove extends parallel to the front edge and extends along the entire length of the front cover. This groove has the purpose of diverting rain water flowing out of the windshield-side edge area of the front cover within this groove upward into the roof area or downward into a windshield wiper trough in such a manner that this rain water cannot arrive in the area of the vehicle side windows.

For the following reasons, such a groove is particularly effective for the desired water removal, as indicated by extensive wind channel tests.

Particularly by a further development of the edge area of he water catching web of the water catching strip according to certain preferred embodiments of the invention, a local flow separation takes place downstream of the front edge of the web. As a result, a strip-shaped region of a flow separation is formed extending along and parallel to the water catching web edge. The size of the flow separation is variable and is to be placed such that the flow again comes to be in contact against the front cover. Precisely in this region, the groove according to certain preferred embodiments of the invention has to extend in the surface of the water catching strip. The width of this groove is smaller than the width of this strip-shaped flow separation region. The depth and the width of the groove to be flatly constructed should be determined experimentally from one case to the next and depends on the amount of water to be carried away. In a specific tested application case, a width of 2 mm and a depth of 1 mm were found to be particularly effective for such a groove.

Although, the groove according to certain preferred embodiments of the invention provide that the side walls extend without an undercut to the surface of the front cover of the water catching strip, they should per se have the purpose of carrying away rain water accumulating in its windshield-side edge area, by means of this groove, rain water undesirably flowing out of the windshield-side water catching channel laterally by way of the front cover, if necessary, can at least partially be carried away by means of this groove at least upward for protecting the side windows from a soiling by rain water.

In the sense of certain preferred embodiments of the invention, a water catching strip with front cover for an A-pillar of the above-mentioned type is at the same time a lateral boundary of a vehicle windshield generally known as a water catching strip, which can be connected in an arbitrary manner with the respective pertaining A-pillar.

In the following, a particularly advantageous embodiment, which will be explained in detail in the following, is illustrated in the drawing.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective view of a windshield area with an adjoining A-pillar of a vehicle, including a water catching strip constructed according to preferred embodiments of the invention; and

FIG. 2 is a sectional view of a water catching strip of the left A-pillar taken along Line II-II in FIG. 1.

### DETAILED DESCRIPTION OF THE DRAWINGS

On the two A-pillars of a vehicle, which laterally bound a windshield 1, one water catching strip 2 respectively forms a transition to the windshield 1. Such a water catching strip 2 can be constructed as a front cover which completely covers the pertaining A-pillar.

The water catching strips 2 are fastened to the respective A-pillars in a customary manner not shown in the drawing. The water catching strips 2 laterally adjoin an A-pillar covering 3.

Toward the windshield 1, each of the water catching strips 2 has a water catching web 4 projecting at a distance with respect to the windshield 1, for forming a water catching channel 5 in cooperation with the windshield 1.

Rain water laterally flowing off the windshield in the case of driving air flow with rain water is carried away in the water catching channel 5 upward into the roof area or into a windshield wiper trough of the vehicle, whereby the adjoining side window remains free of rain water.

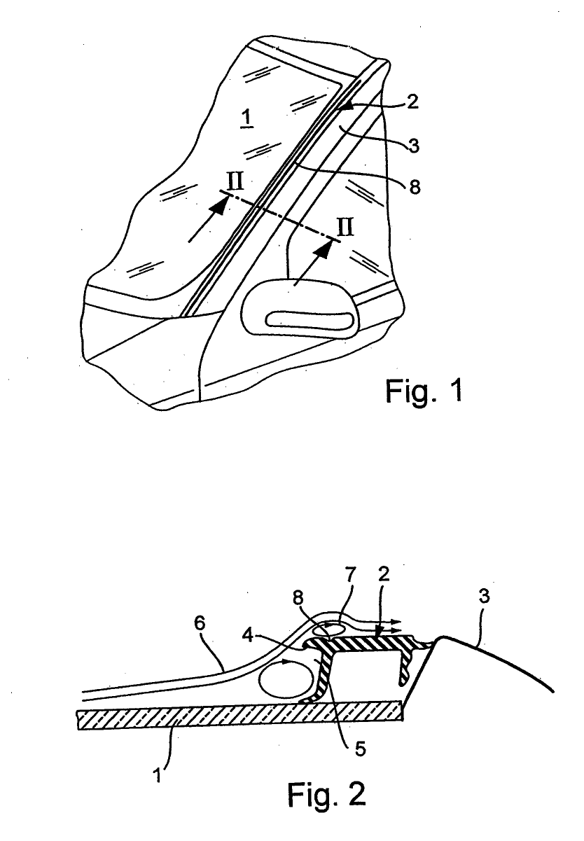

The windshield-side edge of the water catching web 4 is constructed according to the principle of a flow divider, specifically ideally in the shape of a knife-blade-shaped flow divider. In this manner, the direct edge area has a minimal cross-section with respect to a projection surface in the direction of the local outflow of rain water situated laterally in the air subjected to the driving air flow. In FIG. 1, the flowing-off rain water direction is indicated by a flow line 6.

In the drawing, the region of a flow separation forming laterally downstream of the edge of the water catching web 4 is indicated by means of a flow line 7 which is closed in itself. Precisely in the region of this flow separation, the groove 8 according to the invention is arranged in the surface of the water catching strip 2 and extends parallel to the edge of the water catching web 4.

As initially mentioned, the width and the depth of this groove 8 should in each case be experimentally determined from one application case to the next or be determined mathematically by means of simulated flow conditions. In the example shown in the drawing, the depth is 1 mm and the width is 2 mm. The size of the transition radii from the groove 8 into the outer surface of the water catching strip 2 is also important. These radii should be selected to be as small as possible, for which the producibility should also be taken into account.

Although a complete optimal effect of the invention is achieved by a combination of the measures which, on the one hand, relate to the construction of the edge area of the water catching web 4 and, on the other hand, to the groove 8 to be provided downstream of the edge of the water catching web 4, each individual one of these measures basically already results in the object endeavored according to the invention which is to keep the side windows free of rain water. When only one of these two measures is implemented, the success is only less than in the case of a simultaneous implementation of both measures to be endeavored.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A water catching strip which in use is disposed between a vehicle windshield and a vehicle A-pillars comprising:
a water catching channel adjoining a windshield formed between the windshield and a water catching web of the strip projecting at a distance with respect to the windshield, the strip having a predominantly smooth outer surface,
wherein an edge of the water catching web pointing away from the A-pillar toward to the windshield is constructed as a flow divider for rain water flowing laterally off the windshield,
wherein a groove extends parallel to an edge of the strip in an outer surface of the strip at a narrow distance from its water catching web edge,
wherein the groove extends along substantially the entire length of the strip and extends out of the latter in an open manner at least at the top, and
wherein the groove extends in a region of the strip in which, when driving air flow exists, a flow separation is formed downstream of the edge of the water catching web.

2. Front cover according to claim 1, wherein the groove has a flat design and, in comparison to the width of the strip, is designed to be narrow.

3. Front cover according to claim 1, wherein the flow divider water catching web has a blade-shaped construction.

4. Front cover according to claim 2, wherein the flow divider water catching web has a blade-shaped construction.

5. A vehicle assembly comprising:
a vehicle windshield extending between a vehicle roof and a windshield wiper trough,
an A-column bordering a lateral side of the windshield,
a side window disposed behind the A-column at a side of the vehicle, and
a water catching strip operable to control water flow during driving of the vehicle in rain conditions so as to minimize soiling of the side window,
said water catching strip extending along a lateral side of the windshield between the windshield and A-column,
wherein said water catching strip has a cross-sectional profile including:
a cover section extending substantially parallel to and spaced from the windshield surface for guiding rain water laterally of said water catching strip toward the A-column,
a leg section joining the cover section and protruding inwardly thereof to the windshield surface, and
a flow web divider section extending from the wall section laterally inward of the leg section, said web divider section, and cover section together forming a water channel for guiding flow of water vertically along the lateral edge of the windshield to the vehicle roof and/or the windshield wiper trough at a bottom of the windshield,
wherein said cover section includes a groove extending substantially parallel to said water channel and operable to assist in limiting flow of water to said the side window.

6. A vehicle assembly according to claim 5, wherein said groove extends over substantially the entire length of the water catching strip along the lateral side of the window.

7. A vehicle assembly according to claim 5, wherein the groove has a narrow width as compared to the width of the water catching strip.

8. A vehicle assembly according to claim 7, wherein the groove is disposed opposite the leg section.

9. A vehicle assembly according to claim 7, wherein the groove has a flat design with a depth less than its width.

10. A vehicle assembly according to claim 9, wherein the groove has a width of 2 mm and a depth of 1 mm.

11. A vehicle assembly according to claim 5, wherein the flow divider web section has a blade-shaped construction tapering to a point at its laterally inward pointing end.

12. A vehicle assembly according to claim 6, wherein the flow divider web section has a blade-shaped construction tapering to a point at its laterally inward pointing end.

13. A vehicle assembly according to claim 7, wherein the flow divider web section has a blade-shaped construction tapering to a point at its laterally inward pointing end.

14. A vehicle assembly according to claim 9, wherein the flow divider web section has a blade-shaped construction tapering to a point at its laterally inward pointing end.
